(19) United States
(12) Patent Application Publication
(10) Pub. No.: US 2021/0356354 A1
(43) Pub. Date: Nov. 18, 2021

(54) DROP ORIENTATION CONTROL METHOD AND APPARATUS

(71) Applicant: HUAWEI TECHNOLOGIES CO., LTD., SHENZHEN, GUANGDONG (CN)

(72) Inventors: Kai LIU, Dongguan (CN); Mingyu LIU, Wuhan (CN)

(21) Appl. No.: 17/280,736

(22) PCT Filed: Sep. 29, 2018
(86) PCT No.: PCT/CN2018/108871

§ 371 Date: Mar. 26, 2021

(51) Int. Cl. G01M 7/08; H04N 5/232; H04M 1/18

(52) U.S. Cl. CPC G01M 7/08; H04M 2250/52; H04M 1/185; H04N 5/23299

(57) ABSTRACT

Embodiments of this application provide a drop orientation control method and apparatus. A drop orientation control method includes controlling a first orientation generation device to capture a to-be-tested object and drive the to-be-tested object to rotate by a first angle around a first rotation axis. The method further includes controlling the first orientation generation device to transfer the to-be-tested object that rotates by the first angle to the second orientation generation device. Furthermore, the method includes controlling the second orientation generation device to capture the to-be-tested object from the first orientation generation device and drive the to-be-tested object to rotate around by a second angle a second rotation axis. Additionally, the method includes and controlling the second orientation generation device to release the to-be-tested object, to enable the to-be-tested object to drop onto a drop plate, where the first rotation axis and the second rotation axis are perpendicular to each other.

### CROSS-REFERENCE TO RELATED APPLICATIONS

This application is a National Stage of International Application No. PCT/CN2018/108871, filed on Sep. 29, 2018, which is hereby incorporated by reference in its entirety.

### TECHNICAL FIELD

This application relates to the field of communications electronic technologies, and in particular, to a drop orientation control method and apparatus.

### BACKGROUND

A mobile phone has become a portable consumer product around the world. Mobile phones are often dropped during actual application (e.g., due to a phone falling from a user's hand, sliding off a raised surface, etc.). Thus, a drop test of the mobile phone is especially important. A simulation test can be performed on a structure and components such as a liquid crystal display (LCD) module, a printed circuit board assembly (PCBA), and a battery of the mobile phone. The simulation test plays an important role in phases such as mobile phone research and development and quality inspection.

Generally, a random drop test device and a directional drop test device can be used for the drop test on the mobile phone. A roller in the random drop test device can drive the mobile phone to drop, and fully simulate a usage scenario of a user. However, a drop orientation of the mobile phone is uncontrollable and random, and therefore it is impossible to quantitatively analyze a specific drop orientation in which the mobile phone is damaged. The directional drop test device can use a fixed drop orientation to perform the drop test on the mobile phone. However, a quantity of drop orientations is limited and cannot fully cover the usage scenarios of the user.

Therefore, there is an urgent need for a drop orientation control method that can ensure that the drop orientations of the mobile phone are controllable and can fully cover the usage scenarios of the user.

### SUMMARY

This application provides a drop orientation control method and apparatus, to implement a drop test on a to-be-tested object at any rotation angle, and comprehensively simulate various actual orientations of the to-be-tested object.

According to a first aspect, this application provides a drop orientation control method, applied to a drop orientation test device. The drop orientation test device includes a first orientation generation apparatus and a second orientation generation apparatus. The method includes:

controlling the first orientation generation apparatus to capture a to-be-tested object and drive the to-be-tested object to rotate by a first angle around a first rotation axis;

controlling the first orientation generation apparatus to transfer the to-be-tested object that rotates by the first angle to the second orientation generation apparatus;

controlling the second orientation generation apparatus to capture the to-be-tested object from the first orientation generation apparatus and drive the to-be-tested object to rotate by a second angle around a second rotation axis; and

controlling the second orientation generation apparatus to release the to-be-tested object, to enable the to-be-tested object to drop onto a drop plate, where

the first rotation axis and the second rotation axis are perpendicular to each other.

The drop orientation test device can perform repeated drop tests on the to-be-tested object in any direction, to implement performance detection on a structure and components such as an LCD module, a PCBA, and a battery of the to-be-tested object. The performance detection plays an important role in phases such as research and development and quality inspection of the to-be-tested object.

The to-be-tested object may include but is not limited to a mobile phone, a tablet computer (e.g., a pad, tablet, or other computing device), a computer, a virtual reality (VR) terminal, an augmented reality (AR) terminal, and the like. This is not limited herein.

Further, the drop orientation test device may control, by using a control instruction, the first orientation generation apparatus and the second orientation generation apparatus to perform various operations on the to-be-tested object. For example, the various operations include: capturing the to-be-tested object, flipping the to-be-tested object around any rotation axis by any angle, moving the to-be-tested object, releasing the to-be-tested object, transferring the to-be-tested object, and the like.

In this embodiment of this application, the drop orientation test device may control the first orientation generation apparatus or the second orientation generation apparatus to perform any one or any combination of the foregoing operations, or may control the first orientation generation apparatus or the second orientation generation apparatus to perform any combination of the foregoing operations in a preset sequence.

Specific implementations of the first orientation generation apparatus and the second orientation generation apparatus are not limited in this embodiment of this application, provided that the first orientation generation apparatus and the second orientation generation apparatus can implement various operations on the to-be-tested object.

In addition, the drop orientation test device may adjust, based on an actual test requirement, the various operations performed by the first orientation generation apparatus and the second orientation generation apparatus and an operation sequence, to generate a control instruction that meets the actual test requirement. This facilitates to control the first orientation generation apparatus and the second orientation generation apparatus to implement a smooth and flexible operation. In this process, an automatic test on the to-be-tested object can be implemented without manual intervention. This saves test time and costs.

The control instruction may be stored in a storage module of the drop orientation test device itself. This facilitates the drop orientation test device to invoke the control instruction anytime and anywhere, so that the first orientation generation apparatus and the second orientation generation apparatus can be controlled to implement the various operations. The control instruction may also be stored in an external device. The drop orientation test device invokes a control instruction in the external device by connecting to the external device, and may also control the first orientation generation apparatus and the second orientation generation apparatus to implement the various operations. A manner of storing the control instruction is not limited in this embodiment of this application.

The external device in this embodiment of this application includes but is not limited to any device that can store program code, such as a universal serial bus (USB) flash drive, a removable hard disk, a read-only memory (ROM), a random access memory (RAM), a magnetic disk, or an optical disc.

In an embodiment of a specific test process, the first orientation generation apparatus may drive the to-be-tested object to rotate around the first rotation axis in any direction, and the second orientation generation apparatus may drive the to-be-tested object to rotate around the second rotation axis in any direction, where the first rotation axis and the second rotation axis are perpendicular to each other. In this way, the drop orientation test device can rotate the to-be-tested object by any angle, and simulate any rotation angle that may actually occur on the to-be-tested object, namely, various orientations.

Specific directions of the first rotation axis and the second rotation axis are not limited in this embodiment, provided that the first rotation axis and the second rotation axis are perpendicular to each other. For example, if the first rotation axis is a length direction of the to-be-tested object, the second rotation axis is a width direction of the to-be-tested object. If the first rotation axis is a width direction of the to-be-tested object, the second rotation axis is a length direction of the to-be-tested object.

The drop orientation control method provided in the first aspect is applied to the drop orientation test device. The drop orientation test device may divide a rotation angle actually required by the to-be-tested object into a first angle and a second angle based on the first rotation axis and the second rotation axis that are perpendicular to each other. The first orientation generation apparatus rotates the captured to-be-tested object by the first angle around the first rotation axis, and then transfers the to-be-tested object rotated by the first angle to the second orientation generation apparatus, and the second orientation generation apparatus rotates the to-be-tested object rotated by the first angle around the second rotation axis by the second angle, so that the to-be-tested object can present any rotation angle that may actually occur. Then, the second orientation rotation apparatus releases the to-be-tested object at this time to drop the to-be-tested object onto the drop plate, thereby completing the drop test of the to-be-tested object. In this embodiment of this application, the to-be-tested object is separately rotated around the two rotation axes that are perpendicular to each other, so that any actual rotation angle of the to-be-tested object can be generated, and various actual orientations of the to-be-tested object can be comprehensively simulated. This resolves problems with approaches where a usage scenario of a user cannot be fully covered.

In an embodiment of a possible design, the drop orientation test device further includes a placement table.

The controlling the first orientation generation apparatus to capture a to-be-tested object includes:

controlling the first orientation generation apparatus to capture the to-be-tested object from the placement table, where the placement table is configured to place the to-be-tested object.

According to the drop orientation control method provided in embodiments of this implementation, a function of placing the to-be-tested object can be implemented, to ensure that an initial position at which the first orientation generation apparatus captures the to-be-tested object each time is fixed. This not only facilitates the drop orientation test device to calculate the first angle, but also simplifies an operation process of the first orientation generation apparatus. Therefore, the to-be-tested object can be rotated to a more accurate first angle. This improves accuracy of a test result. In addition, the placement table may further be provided with a function of flipping front and rear sides of the to-be-tested object. This can simplify a process of calculating the first angle by the drop orientation test device and an operation process of the first orientation generation apparatus, and save time of the drop test.

In an embodiment of a possible design, the method further includes:

controlling the placement table to drive the to-be-tested object to rotate until a preset surface of the to-be-tested object faces a capturing direction of the first orientation generation apparatus.

In an embodiment of a possible design, the first orientation generation apparatus includes a mechanical arm and a first capturing apparatus.

The first capturing apparatus is configured to capture the to-be-tested object, and the mechanical arm is configured to drive the to-be-tested object to rotate.

In an embodiment of a possible design, before the controlling the second orientation generation apparatus to release the to-be-tested object, the method further includes:

controlling the second orientation generation apparatus to move to a first preset height.

In an embodiment of a possible design, the controlling the second orientation generation apparatus to release the to-be-tested object includes:

controlling the second orientation generation apparatus that captures the to-be-tested object to freely drop until the second orientation generation apparatus releases the to-be-tested object when the second orientation generation apparatus is at a second preset height.

According to the drop orientation control method provided in embodiments of this implementation, an actual drop process of the to-be-tested object can be more closely and comprehensively simulated, so that in a time period in which the to-be-tested object drops from the first preset height to the second preset height, the second orientation generation apparatus is in a weightlessness state together with the to-be-tested object and freely drops together with the to-be-tested object. This ensures that an initial rotation angle remains unchanged when the to-be-tested object drops from the second preset height to the drop plate, to facilitate detection of performance of the to-be-tested object at different rotation angles. Therefore, a test process of directional dropping is implemented, and accuracy and reliability of the drop test of the to-be-tested object are effectively improved.

In another embodiment of a possible design, the second orientation generating apparatus includes a drop support and a drop body.

The drop support includes a guide rail, and the drop body moves upward and downward along the guide rail.

The drop body is configured to capture the to-be-tested object and drive the to-be-tested object to rotate.

In an embodiment of a possible design, the drop body includes a drop head and a second capturing apparatus.

The second capturing apparatus is configured to capture the to-be-tested object, and the drop head is configured to drive the to-be-tested object to rotate.

In an embodiment of a possible design, the drop head includes an upper drop head and a lower drop head.

The upper drop head is configured to drive the drop body to move upward and downward, and drive the lower drop head to drive the to-be-tested object to freely drop.

According to the drop orientation control method provided in embodiments of this implementation, in a process of releasing the to-be-tested object, the upper drop head continues to remain on the guide rail, and only the lower drop head drives the to-be-tested object to drop freely. This reduces an impact on free dropping of the to-be-tested object due to a weight of the drop head, and ensures that a motion from the first preset height to the second preset height of the to-be-tested object is free dropping.

In an embodiment of a possible design, the method further includes:

controlling a camera to take a picture of the to-be-tested object dropping onto the drop plate; and

controlling, based on the picture, the first orientation generation apparatus to capture the to-be-tested object and place the to-be-tested object on the placement table.

According to the drop orientation control method provided in embodiments of this implementation, the drop orientation test device may detect, based on the picture taken by the camera, whether the to-be-tested object drops onto the drop plate. Further, when the to-be-tested object drops onto the drop plate, the drop orientation test device may control the first orientation generation apparatus to capture the to-be-tested object and place the to-be-tested object on the placement table. This facilitates the drop orientation test device to start a next drop test of the to-be-tested object, to ensure continuity of each drop test.

In an embodiment of a possible design, the controlling a camera to take a picture of the to-be-tested object dropping onto the drop plate includes:

controlling the camera to take the picture at an initial moment when the to-be-tested object is in contact with the drop plate.

In an embodiment of a possible design, the camera includes at least one of a high-speed camera and an industrial camera.

In a possible design, four barriers are disposed at four sides of the drop plate.

The barriers are configured to prevent the to-be-tested object from dropping out of the drop plate.

According to the drop orientation control method provided in embodiments of this implementation, the four barriers are disposed to prevent the to-be-tested object from dropping out of the drop plate, protect another apparatus in the drop orientation test device, and prevent the to-be-tested object from popping out of the drop plate, or prevent the to-be-tested object and/or the drop plate from colliding with each other and causing components of the to-be-tested object and/or residue of the drop plate to be splashed.

The barriers may be fixedly disposed at the four sides of the drop plate, or may be movably connected to the four sides of the drop plate. In addition, the barriers may be transparent, so that the camera can easily take the picture on the to-be-tested object on the drop plate. A specific height of the barriers may be set according to a size of the to-be-tested object. This is not limited in this embodiment.

In an embodiment of a possible design, the method further includes:

if the to-be-tested object leans against the barriers, controlling the barriers to be extracted from the drop position, to enable the to-be-tested object to slide down and lie on the drop plate, so that the first orientation generation apparatus captures the to-be-tested object.

In an embodiment of a possible design, the method further includes:

determining, based on the picture, whether the to-be-tested object leans against the barriers.

In an embodiment of a possible design, the drop orientation test device further includes a cleaning mechanism; and

after the controlling the first orientation generation apparatus to capture the to-be-tested object, the method further includes:

controlling the cleaning mechanism to clear sundries on the drop plate from the drop plate.

According to the drop orientation control method provided in embodiments of this implementation, the cleaning mechanism is disposed to enable that the to-be-tested object only collides with the drop plate during a next drop test of the to-be-tested object, and is not affected by the sundries on the drop plate. Therefore, an impact of a material of the drop plate on performance of the to-be-tested object can be accurately analyzed.

A specific implementation form of the cleaning mechanism is not limited in this embodiment of this application. For example, the cleaning mechanism may specifically include: a cleaning roller and a sundry storage apparatus, where the cleaning roller may be disposed on at least one of the four sides of the drop plate, and the sundry storage apparatus may be disposed on an opposite side of the cleaning roller, or may be disposed below the drop plate, or may be disposed on edges of the four sides of the drop plate, so that the cleaning roller rotates on the drop plate to clean the sundries into the sundry storage apparatus, to clear the drop plate.

In an embodiment of a possible design, the drop orientation test device further includes a drop plate replacement apparatus;

after the controlling the first orientation generation apparatus to capture the to-be-tested object, the method further includes:

controlling the drop plate replacement apparatus to replace a current drop plate with another drop plate.

According to the drop orientation control method provided in embodiments of this implementation, the drop plate replacement apparatus can be disposed to replace a damaged drop plate in time, to ensure that performance of the drop plate is not affected by an irrelevant factor in a drop test process, and to further fully cover a scenario in which a user drops the to-be-tested object.

In an embodiment of a possible design, a material of the current drop plate is different from a material of the another drop plate.

In an embodiment of a possible design, a material of the drop plate is any one of glass, wood, asphalt, and marble.

According to a second aspect, this application provides a drop orientation test device. The drop orientation test device includes: a first orientation generation apparatus and a second orientation generation apparatus.

The first orientation generation apparatus is configured to capture a to-be-tested object and drive the to-be-tested object to rotate by a first angle around a first rotation axis.

The first orientation generation apparatus is further configured to transfer the to-be-tested object that rotates by the first angle to the second orientation generation apparatus.

The second orientation generation apparatus is configured to capture the to-be-tested object from the first orientation generation apparatus and drive the to-be-tested object to rotate by a second angle around a second rotation axis.

The second orientation generation apparatus is further configured to release the to-be-tested object, to enable the to-be-tested object to drop onto a drop plate.

The first rotation axis and the second rotation axis are perpendicular to each other.

In an embodiment of a possible design, the drop orientation test device further includes a placement table;

the placement table is configured to place the to-be-tested object; and

the first orientation generation apparatus is configured to capture the to-be-tested object from the placement table.

In an embodiment of a possible design, the placement table is further configured to drive the to-be-tested object to rotate until a preset surface of the to-be-tested object faces a capturing direction of the first orientation generation apparatus.

In an embodiment of a possible design, the first orientation generation apparatus includes a mechanical arm and a first capturing apparatus, where

the first capturing apparatus is configured to capture the to-be-tested object, and the mechanical arm is configured to drive the to-be-tested object to rotate.

In an embodiment of a possible design, the second orientation generation apparatus is further configured to move to a first preset height before releasing the to-be-tested object.

In an embodiment of a possible design, the second orientation generation apparatus is specifically configured to capture the to-be-tested object to freely drop until the second orientation generation apparatus releases the to-be-tested object when the second orientation generation apparatus is at a second preset height.

In an embodiment of another possible design, the second orientation generating apparatus includes a drop support and a drop body, where

the drop support includes a guide rail, and the drop body moves upward and downward along the guide rail; and

the drop body is configured to capture the to-be-tested object and drive the to-be-tested object to rotate.

In an embodiment of a possible design, the drop body includes a drop head and a second capturing apparatus, where

the second capturing apparatus is configured to capture the to-be-tested object, and the drop head is configured to drive the to-be-tested object to rotate.

In an embodiment of a possible design, the drop head includes an upper drop head and a lower drop head, where

the upper drop head is configured to drive the drop body to move upward and downward, and drive the lower drop head to drive the to-be-tested object to freely drop.

In an embodiment of a possible design, the drop orientation test device further includes a camera; and

the camera is configured to take a picture of the to-be-tested object dropping onto the drop plate; and

the first orientation generation apparatus is configured to capture the to-be-tested object and place the to-be-tested object on the placement table.

In an embodiment of a possible design, the camera is specifically configured to take the picture at an initial moment when the to-be-tested object is in contact with the drop plate.

In an embodiment of a possible design, the camera includes at least one of a high-speed camera and an industrial camera.

In an embodiment of a possible design, four barriers are disposed at four sides of the drop plate, where

the barriers are configured to prevent the to-be-tested object from dropping out of the drop plate.

In an embodiment of a possible design, the barriers are further configured to be extracted from the drop position when the to-be-tested object leans against the barriers, to enable the to-be-tested object to slide down and lie on the drop plate, so that the first orientation generation apparatus captures the to-be-tested object.

In an embodiment of a possible design, the drop orientation test device further includes a cleaning mechanism; and

the cleaning mechanism is configured to: after the first orientation generation apparatus captures the to-be-tested object, clear sundries on the drop plate from the drop plate.

In an embodiment of a possible design, the drop orientation test device further includes a drop plate replacement apparatus;

the drop plate replacement apparatus is configured to replace a current drop plate with another drop plate after the first orientation generation apparatus captures the to-be-tested object.

In an embodiment of a possible design, a material of the current drop plate is different from a material of the another drop plate.

In an embodiment of a possible design, a material of the drop plate is any one of glass, wood, asphalt, and marble.

For beneficial effects of the drop orientation test device provided in the second aspect and the possible designs of the second aspect, refer to the beneficial effects brought by the first aspect and the possible implementations of the first aspect. Details are not described herein again.

According to a third aspect, this application provides an electronic device. The electronic device includes a communications interface, a memory, and a processor, where the memory is configured to store a program instruction, and the processor is configured to invoke the program instruction in the memory to perform the drop orientation control method in any one of the first aspect or the possible designs of the first aspect.

According to a fourth aspect, this application provides a readable storage medium. The readable storage medium stores an execution instruction. When at least one processor of an electronic device executes the execution instruction, the electronic device performs the drop orientation control method in any one of the first aspect or the possible designs of the first aspect.

According to a fifth aspect, this application provides a program product. The program product includes an execution instruction, and the execution instruction is stored in a readable storage medium. At least one processor of an electronic device may read the executable instruction from the readable storage medium, and the at least one processor executes the executable instruction, so that the electronic device implements the drop orientation control method in any one of the first aspect or the possible designs of the first aspect.

According to a sixth aspect, this application provides a chip. The chip is connected to a memory, or a memory is integrated in the chip, and when a software program stored in the memory is executed, any one of the foregoing drop orientation control methods is implemented.

The drop orientation control method and apparatus is provided in this embodiment of this application. The method is applied to the drop orientation test device, and the drop orientation control apparatus divides the rotation angle actually required by the to-be-tested object into the first angle and the second angle based on the first rotation axis and the second rotation axis that are perpendicular to each other. Then, the first orientation generation apparatus is controlled to rotate the captured to-be-tested object by the first angle around the first rotation axis, the first orientation generation apparatus is controlled to transfer the to-be-tested object rotated by the first angle to the second orientation generation apparatus, and the second orientation generation apparatus is controlled to rotate the to-be-tested object rotated by the first angle around the second rotation axis by the second angle, so that the to-be-tested object presents any rotation angle that may actually occur. Then, the second orientation rotation apparatus is controlled to release the to-be-tested object at this time, so that the to-be-tested object drops onto the drop plate, to complete the drop test process of the to-be-tested object. In this embodiment of this application, the to-be-tested object is separately rotated around the two rotation axes that are perpendicular to each other, so that any actual rotation angle of the to-be-tested object can be generated, and various actual orientations of the to-be-tested object can be comprehensively simulated. This resolves problems with approaches where a usage scenario of a user cannot be fully covered.

### BRIEF DESCRIPTION OF DRAWINGS

FIG. 1 is a schematic structural diagram of a drop orientation test device according to an embodiment of this application;

FIG. 2 is a flowchart of a drop orientation control method according to an embodiment of this application;

FIG. 3 is a schematic structural diagram of a placement table in a drop orientation test device according to an embodiment of this application;

FIG. 4 is a schematic structural diagram of a flipping apparatus in a drop orientation test device according to an embodiment of this application;

FIG. 5 is a schematic structural diagram of a first orientation generation apparatus in a drop orientation test device according to an embodiment of this application;

FIG. 6 is a schematic structural diagram of a second orientation generation apparatus in a drop orientation test device according to an embodiment of this application;

FIG. 7 is a schematic structural diagram of another apparatus in a drop orientation test device according to an embodiment of this application;

FIG. 8 is a schematic structural diagram of a drop orientation test device according to another embodiment of this application; and

FIG. 9 is a schematic diagram of a hardware structure of an electronic device according to an embodiment of this application.

### DETAILED DESCRIPTION

The following describes the technical solutions in the embodiments of this application with reference to the accompanying drawings in the embodiments of this application.

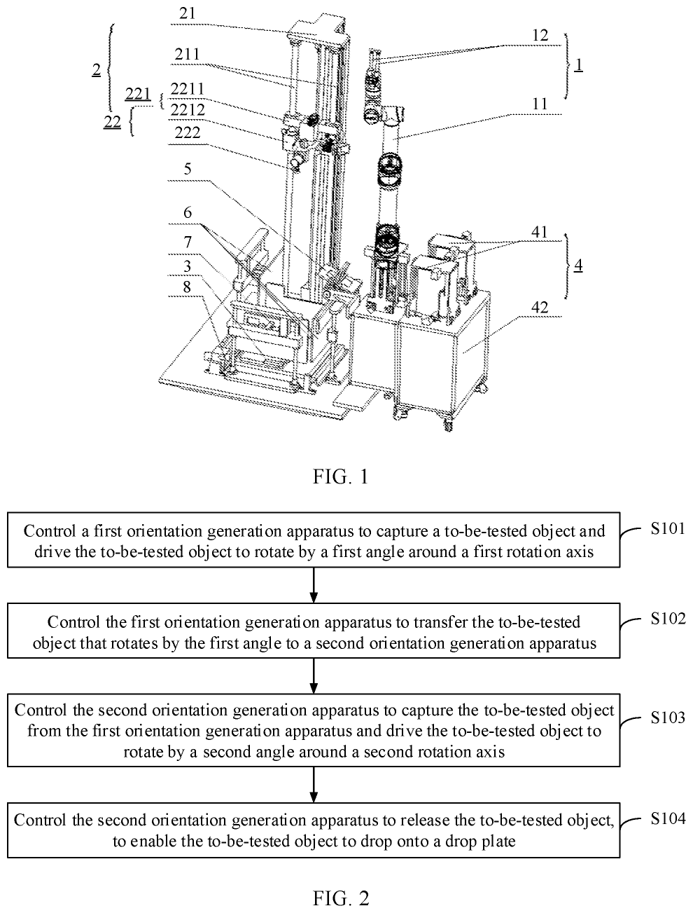

FIG. 1 is a schematic structural diagram of a drop orientation test device according to an embodiment of this application. In this embodiment of this application, the drop orientation test device can perform repeated drop tests on the to-be-tested object in any direction, to implement performance detection on a structure and components such as an LCD module, a PCBA, and a battery of the to-be-tested object. The performance detection plays an important role in phases such as research and development and quality inspection of the to-be-tested object.

The to-be-tested object may include but is not limited to a mobile phone, a tablet computer (e.g., a pad, tablet, or other computing device), a computer, a virtual reality (VR) terminal, an augmented reality (AR) terminal, and the like. This is not limited herein.

As shown in FIG. 1, the drop orientation test device may include a first orientation generation apparatus 1 and a second orientation generation apparatus 2. The drop orientation test device may control, by using a control instruction, the first orientation generation apparatus 1 and the second orientation generation apparatus 2 to perform various operations on the to-be-tested object. For example, the various operations include: capturing the to-be-tested object, flipping the to-be-tested object around any rotation axis by any angle, moving the to-be-tested object, releasing the to-be-tested object, transferring the to-be-tested object, and the like.

In this embodiment of this application, the drop orientation test device may control the first orientation generation apparatus 1 or the second orientation generation apparatus 2 to perform any one or any combination of the foregoing operations, or may control the first orientation generation apparatus 1 or the second orientation generation apparatus 2 to perform any combination of the foregoing operations in a preset sequence.

Specific implementations of the first orientation generation apparatus 1 and the second orientation generation apparatus 2 are not limited in this embodiment of this application, provided that the first orientation generation apparatus 1 and the second orientation generation apparatus 2 can implement various operations on the to-be-tested object.

In addition, the drop orientation test device may adjust, based on an actual test requirement, the various operations performed by the first orientation generation apparatus 1 and the second orientation generation apparatus 2 and an operation sequence, to generate a control instruction that meets the actual test requirement. This facilitates to control the first orientation generation apparatus 1 and the second orientation generation apparatus 2 to implement a smooth and flexible operation. In this process, an automatic test on the to-be-tested object can be implemented without manual intervention. This saves test time and costs.

The control instruction may be stored in a storage module of the drop orientation test device itself. This facilitates the drop orientation test device to invoke the control instruction anytime and anywhere, so that the first orientation generation apparatus 1 and the second orientation generation apparatus 2 can be controlled to implement the various operations. The control instruction may also be stored in an external device. The drop orientation test device invokes a control instruction in the external device by connecting to the external device, and may also control the first orientation generation apparatus 1 and the second orientation generation apparatus 2 to implement the various operations. A manner of storing the control instruction is not limited in this embodiment of this application.

The external device in this embodiment of this application includes but is not limited to any device that can store program code, such as a USB flash drive, a removable hard disk, a read-only memory (ROM), a random access memory (RAM), a magnetic disk, or an optical disc.

In an embodiment of a specific test process, the first orientation generation apparatus 1 may drive the to-be-tested object to rotate around the first rotation axis in any direction, the second orientation generation apparatus 2 may drive the to-be-tested object to rotate around the second rotation axis in any direction, where the first rotation axis and the second rotation axis are perpendicular to each other. In this way, the drop orientation test device can rotate the to-be-tested object by any angle, and simulate any rotation angle that may actually occur on the to-be-tested object, namely, various orientations.

Specific directions of the first rotation axis and the second rotation axis are not limited in this embodiment, provided that the first rotation axis and the second rotation axis are perpendicular to each other. For example, if the first rotation axis is a length direction of the to-be-tested object, the second rotation axis is a width direction of the to-be-tested object. If the first rotation axis is a width direction of the to-be-tested object, the second rotation axis is a length direction of the to-be-tested object.

It should be noted that, if the second orientation generation apparatus 2 or the first orientation generation apparatus 1 cannot implement flipping of front and rear sides of the to-be-tested object, the drop orientation test device may implement −180° to 180° flipping on the to-be-tested object by using one of the first orientation generation apparatus 1 and the second orientation generation apparatus 2, and implement −90° to 90° flipping on the to-be-tested object by using the other apparatus. Another apparatus that can implement flipping can flip the front and rear sides of the to-be-tested object. This simulates an actual rotation angle of the to-be-tested object. In addition, in addition to presenting any rotation angle of the to-be-tested object by using the first orientation generation apparatus 1 and the second orientation generation apparatus 2, the drop orientation test device may further rotate the to-be-tested object by using one orientation generation apparatus, so that the to-be-tested object may present any rotation angle that may actually occur. A specific implementation form of the drop orientation test device is not limited in this embodiment of this application.

For ease of description, the following describes in detail a specific implementation process of the drop orientation control method in this embodiment of this application with reference to FIG. 2 to FIG. 8 by using an example in which the drop orientation test device includes the first orientation generation apparatus 1 and the second word orientation generation apparatus.

As shown in FIG. 2, the drop orientation control method in this embodiment of this application may include the following steps.

S101: Control the first orientation generation apparatus to capture a to-be-tested object and drive the to-be-tested object to rotate by a first angle around a first rotation axis.

S102: Control the first orientation generation apparatus to transfer the to-be-tested object that rotates by the first angle to the second orientation generation apparatus.

In this embodiment of this application, when the drop orientation test device receives any rotation angle entered by an operator, the drop orientation test device may obtain the first angle and a second angle respectively along the first rotation axis and a second rotation axis by using the rotation angle, and generates a control instruction for controlling the first orientation generation apparatus 1 and a control instruction for controlling the second orientation generation apparatus 2. Further, under control of the drop orientation test device, the first orientation generation apparatus 1 may capture the to-be-tested object and drive the to-be-tested object to rotate around the first rotation axis by the first angle;

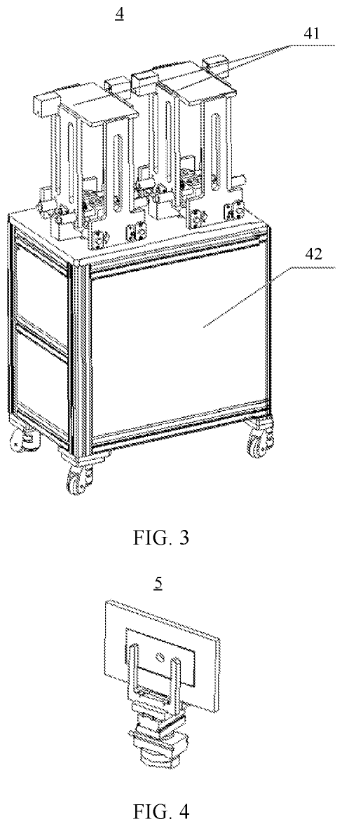

As shown in FIG. 3, to ensure accuracy of the first angle, the drop orientation test device may further include a placement table 4. The drop orientation test device may control the first orientation generation apparatus 1 to capture the to-be-tested object from the placement table 4, and the placement table 4 is configured to place the to-be-tested object. Further, the placement table 4 is disposed to ensure that an initial position at which the first orientation generation apparatus 1 captures the to-be-tested object each time is fixed. This not only facilitates the drop orientation test device to calculate the first angle, but also simplifies an operation process of the first orientation generation apparatus 1. Therefore, the to-be-tested object can be rotated to a more accurate first angle. This improves accuracy of a test result.

In addition, after the first orientation generation apparatus 1 captures the to-be-tested object, the drop orientation test device may further control the first orientation generation apparatus 1 to drive the to-be-tested object to rotate to the initial position, and then rotate the to-be-tested object around the first rotation axis until the to-be-tested object in the initial position rotates around the first rotation axis by the first angle. This can also ensure accuracy of the first angle.

Further, in addition to placing the to-be-tested object, the placement table 4 may further flip the to-be-tested object. Because the to-be-tested object includes a front side and a rear side, and when a drop test is performed on the front side or the rear side of the to-be-tested object towards a dropping direction, a test result differs, and performance detection of the to-be-tested object is affected. Therefore, in this embodiment of this application, after receiving the rotation angle of the to-be-tested object, the drop orientation test device may determine whether the front side or the back side of the to-be-tested object is a preset side of the to-be-tested object. In other words, the preset side is a capturing direction towards the first orientation generation apparatus 1. In addition, because the to-be-tested object is randomly placed on the placement table 4, the drop orientation test device may determine, by detecting the front side or the back side of the to-be-tested object, whether to flip the to-be-tested object. The foregoing process of determining the preset side of the to-be-tested object by the drop orientation test device and the process of detecting the front side or the back side of the to-be-tested object by the drop orientation test device have no time sequence, and may be simultaneously performed, or may be sequentially performed.

Further, when the to-be-tested object needs to be flipped, the drop orientation test device may control the placement table 4 to drive the to-be-tested object to rotate until the preset side of the to-be-tested object faces the capturing direction of the first orientation generation apparatus 1, so that the drop orientation test device may preferentially consider the front and rear sides of the to-be-tested object. A calculation process of calculating the first angle by the drop orientation test device and an operation process of the first orientation generation apparatus 1 are simplified by using a rotation function of the drop orientation test device 4, so that the first orientation generation apparatus 1 can more accurately rotate the to-be-tested object around the first rotation axis by the first angle.

One or more placement positions 41 of the to-be-tested object may be disposed on the placement table 4, and a module with a flipping function may be disposed at the one or more placement positions 41, to save space of the drop orientation test device. A specific implementation of the placement table 4 is not limited in this embodiment of this application. For ease of description, the placement table 4 in FIG. 3 shows two placement positions 41 of two to-be-tested objects and a storage container 42 of the to-be-tested object with a pulley. The operator may transmit the to-be-tested object to the storage container 42 through a transmission channel 12 of the to-be-tested object, and the storage container 42 further includes a wire connecting plate. Under an action of the wire connecting plate, the to-be-tested object may be placed at a corresponding position, or the to-be-tested object may be flipped.

In addition, as shown in FIG. 4, the drop orientation test device may further include: a flipping apparatus 5, where the flipping apparatus 5 independently performs a function of flipping the to-be-tested object, and the placement table 4 independently performs a function of placing the to-be-tested object, and separates the function of placing the to-be-tested object from the function of flipping the to-be-tested object, to facilitate an operation of another device in the drop orientation test device.

Further, after the first orientation generation apparatus 1 rotates the to-be-tested object by the first angle, under the control of the drop orientation test device, the first orientation generation apparatus 1 may transfer the to-be-tested object rotated by the first angle to the second orientation generation apparatus 2. In addition, to facilitate a next drop test of the to-be-tested object, after the first orientation generation apparatus 1 transfers the to-be-tested object to the second orientation generation apparatus 2, the drop orientation test device may control the first orientation generation apparatus 1 to restore to the initial position, to prepare for the next drop test of the to-be-tested object. In addition, after completing one drop test of the to-be-tested object, the drop orientation test device may also control the first orientation generation apparatus 1 to restore to the initial position. This is not limited in this embodiment of this application.

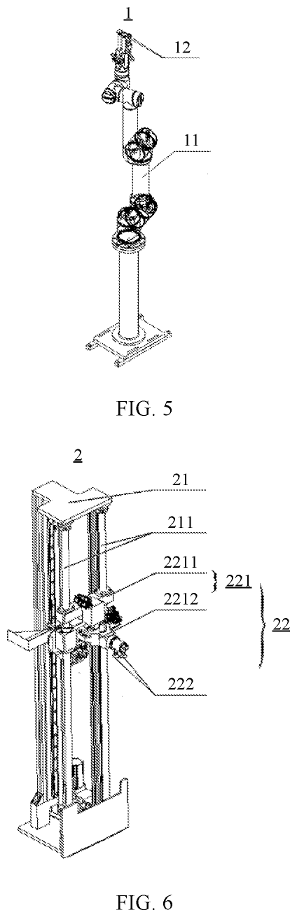

As shown in FIG. 5, in this embodiment of this application, the first orientation generation apparatus 1 may be functionally divided into two parts: a mechanical arm 11 and a first capturing apparatus 12. The first capturing apparatus 12 is configured to capture the to-be-tested object, and the mechanical arm 11 is configured to drive the to-be-tested object to rotate. Generally, the first capturing apparatus 12 may be disposed at an end of the mechanical arm 11. Therefore, under the control of the drop orientation test device, after the first capturing apparatus 12 fixedly captures the to-be-tested object, the first capturing apparatus 12 and the to-be-tested object may rotate as the mechanical arm 11 rotates, so that the to-be-tested object rotates around the first rotation axis by the first angle. The first capturing apparatus 12 may be a suction cup or a fixture. A quantity, a shape, and a size of the suction cup or the fixture may be set according to an actual situation. The mechanical arm 11 may include but is not limited to a six-axis collaborative mechanical arm or the like. In FIG. 5, the first capturing apparatus 12 is shown by using two suction cups, and the mechanical arm 11 is shown by using the six-axis collaborative mechanical arm.

As further shown in FIG. 2, the drop orientation control method in this embodiment of this application also includes the following steps.

S103: Control the second orientation generation apparatus to capture the to-be-tested object from the first orientation generation apparatus and drive the to-be-tested object to rotate by a second angle around a second rotation axis.

S104: Control the second orientation generation apparatus to release the to-be-tested object, to enable the to-be-tested object to drop onto a drop plate.

In this embodiment of this application, under the control of the drop orientation test device, the second orientation generation apparatus 2 may capture the to-be-tested object from the first orientation generation apparatus 1 while keeping the orientation of the to-be-tested object rotated by the first angle unchanged, and drive the to-be-tested object that rotates by the first angle to rotate around the second rotation axis by the second angle. In this way, the drop orientation test device rotates the to-be-tested object to the rotation angle set by the operator. Further, the drop orientation test device may control the second orientation generation apparatus 2 to release the to-be-tested object, so that the to-be-tested object drops onto the drop plate 3, to complete one drop test of the to-be-tested object.

Further, because a height is one of factors that affect the drop test performed on the to-be-tested object, before controlling the second orientation generation apparatus 2 to release the to-be-tested object, the drop orientation test device may control the second orientation generation apparatus 2 to move to a first preset height.

When only an impact of the rotation angle on test performance of the to-be-tested object is detected, the drop orientation test device may change, on a premise that the second orientation generation apparatus 2 is controlled to keep the first preset height of the to-be-tested object unchanged each time the second orientation generation apparatus 2 releases the to-be-tested object, the rotation angle of the to-be-tested object, to enable the to-be-tested object to perform a drop test at a same initial height. Therefore, the impact of the rotation angle on performance of the to-be-tested object is detected.

When only an impact of the height on performance of the to-be-tested object is detected, the drop orientation test device may control, on a premise that the rotation angle of the to-be-tested object remains unchanged, changing of the first preset height of the to-be-tested object released by the second orientation generation apparatus 2, to enable the to-be-tested object to perform a drop test at different heights. Therefore, the impact of the height on performance of the to-be-tested object is detected.

Further, to be closer to and comprehensively simulate an actual drop process of the to-be-tested object, in this embodiment of this application, when the drop orientation test device controls the second orientation generation apparatus 2 to release the to-be-tested object, the second orientation generation apparatus 2 used to capture the to-be-tested object may be controlled to freely drop, and the to-be-tested object is released until the second orientation generation apparatus 2 is located at the second preset height, so that in a time period in which the to-be-tested object drops from the first preset height to the second preset height, the second orientation generation apparatus 2 is in a weightlessness state together with the to-be-tested object and freely drops together with the to-be-tested object. This ensures that an initial rotation angle remains unchanged when the to-be-tested object drops from the second preset height to the drop plate 3, to facilitate detection of performance of the to-be-tested object at different rotation angles. Therefore, a test process of directional dropping is improved, and accuracy and reliability of the drop test are effectively improved.

The second preset height may be set based on actual experience. This is not limited in this embodiment of this application. Generally, the second preset height is 20 cm to 30 cm.

As shown in FIG. 6, in this embodiment of this application, the second orientation generation apparatus 2 may be functionally divided into two parts: a drop support 21 and a drop body 22. The drop support 21 includes a guide rail 211. A quantity of guide rails 211 may be set according to an actual situation, in FIG. 6, two guide rails 211 are used as an example. The drop body 22 may capture, from the first orientation generation apparatus 1, the to-be-tested object that rotates by the first angle, and may drive the to-be-tested object to rotate around the second rotation axis. In addition, the drop body 22 may move upward and downward along the guide rail, to adjust a drop height of the to-be-tested object by using the drop orientation test device.

A specific implementation form of the drop support 21 and the drop body 22 are not limited in this embodiment of this application. Optionally, still with reference to FIG. 6, the drop body 22 may include: a drop head 221 and a second capturing apparatus 222. The second capturing apparatus 222 is configured to capture the to-be-tested object, and the drop head 221 is configured to drive the to-be-tested object to rotate, to separate a capturing function from a rotation function of the drop body 22. This facilitates the drop orientation test device to control the drop body 22.

The second capturing apparatus 222 may be a suction cup or a fixture. A quantity, a shape, and a size of the suction cup or the fixture may be set according to an actual situation. The drop body may be integrally formed, or may be disposed separately. Optionally, the drop head 221 may include an upper drop head 2211 and a lower drop head 2212. The upper drop head 2211 is configured to drive the drop body 22 to move upward and downward, so that the drop orientation test device can adjust the drop height of the to-be-tested object. The upper drop head 2211 may drive the lower drop head 2212 to drive the to-be-tested object to freely drop, so that the upper drop head 2211 continues to remain on the guide rail, and only the lower drop head drives the to-be-tested object to drop freely. This reduces an impact on free dropping of the to-be-tested object due to a weight of the drop head 221, and ensures that a motion from the first preset height to the second preset height of the to-be-tested object is free dropping. In FIG. 6, the second capturing apparatus 222 is shown by using two suction cups, and the drop head 221 includes the upper drop head 2211 and the lower drop head 2212.

Further, to accurately analyze performance of the to-be-tested object, a plurality of drop tests usually need to be performed on the to-be-tested object. Therefore, to ensure continuity of each drop test, the drop orientation test device may further include a camera (not shown in FIG. 1). The drop orientation test device may control the camera to take a picture of the to-be-tested object dropping onto the drop plate 3. In this way, the drop orientation test device may detect, based on the picture, whether the to-be-tested object drops onto the drop plate 3. Further, when the to-be-tested object drops onto the drop plate 3, the drop orientation test device may control the first orientation generation apparatus 1 to capture the to-be-tested object and place the to-be-tested object on the placement table 4. This facilitates the drop orientation test device to start a next drop test of the to-be-tested object.

In addition, the drop orientation test device may further use the camera to take at least one picture in a process of performing the drop test on the to-be-tested object. For example, the camera may take a picture corresponding to the to-be-tested object rotated by the first angle by the first orientation generation apparatus 1, take a picture corresponding to the to-be-tested object that starts to rotate by the first angle by the second orientation generation apparatus 2, or take a picture corresponding to the to-be-tested object rotated by the second angle by the second orientation generation apparatus 2 after rotating by the first angle, and the like. Further, the drop orientation test device may detect, based on the picture, whether the to-be-tested object is at a rotation angle corresponding to a photographing moment, to ensure that the to-be-tested object is at an actual required rotation angle before the to-be-tested object is released by ensuring an orientation of the to-be-tested object in each phase, and to implement accurate test of the performance of to-be-tested object.

A position, a quantity, and a model of the camera are not limited in this embodiment of this application. For example, the camera includes at least one of a high-speed camera and an industrial camera.

In order to save time for performing a drop test on the to-be-tested object, the drop orientation test device may detect, by using a sensor or another detection apparatus, whether the to-be-tested object is in contact with the drop plate 3. Therefore, once the to-be-tested object is in contact with the drop plate 3, the sensor or the another detection apparatus may send a trigger signal to the drop orientation test device, so that the drop orientation test device may control the camera to take a picture at an initial moment when the to-be-tested object is in contact with the drop plate 3. This saves time and costs of the drop test.

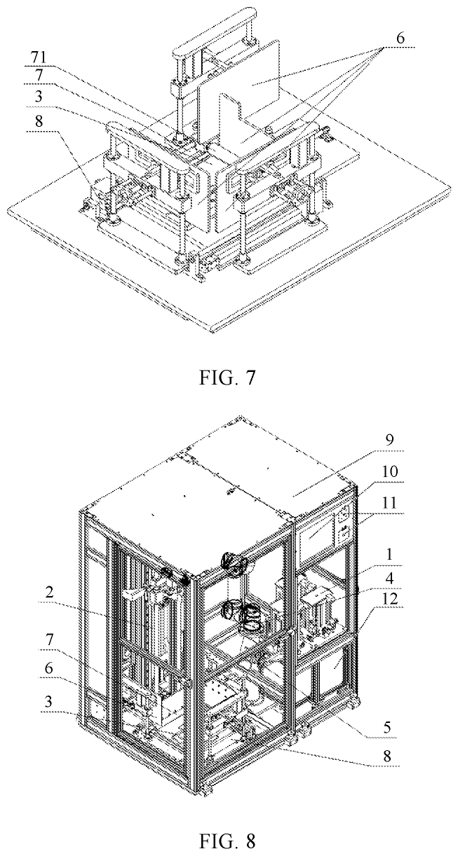

Further, when the to-be-tested object drops onto the drop plate 3, the to-be-tested object may pop out of the drop plate 3, or components of the to-be-tested object and/or residue of the drop plate 3 may be splashed due to collision of the to-be-tested object and/or the drop plate 3, and a splashed object is likely to collide with another apparatus in the drop orientation test device. An operation and usage of the another device are affected, and even personal safety of the operator is affected. Therefore, as shown in FIG. 7, the drop orientation test device may further be provided with four barriers 6 at four sides of the drop plate 3, and the barriers 6 may be disposed to prevent the to-be-tested object from dropping out of the drop plate 3, to protect the another apparatus in the drop orientation test device.

The barriers 6 may be fixedly disposed at the four sides of the drop plate 3, or may be movably connected to the four sides of the drop plate 3. In addition, the barriers 6 may be transparent, so that the camera can easily take the picture on the to-be-tested object on the drop plate 3. A specific height of the barriers 6 may be set according to a size of the to-be-tested object. This is not limited in this embodiment.

Further, disposing of the barriers 6 inevitably causes a phenomenon that the to-be-tested object leans against the barriers. This is inconvenient for a capturing process of the first orientation generation apparatus 1. In order to resolve this problem, in this embodiment of this application, the drop orientation test device may detect the to-be-tested object at a position of the drop plate 3 by using the camera. Specifically, the drop orientation test device may determine, based on the picture, whether the to-be-tested object leans against the barriers 6. If the to-be-tested object leans against the barriers, the drop orientation test device may control the barriers to be extracted up, down, left, or right from the drop position, so that the to-be-tested object drops and lies on the drop plate 3. In this way, the drop orientation test device controls the first orientation generation apparatus 1 to capture the to-be-tested object and place the to-be-tested object on the placement table 4, to facilitate to detect the to-be-tested object or perform a next drop test on the to-be-tested object.

Still with reference to FIG. 7, to prevent sundries on the drop plate 3 from affecting a result of the drop test on the to-be-tested object, in this embodiment of this application, the drop orientation test device may further include a cleaning mechanism 7. After controlling the first orientation generation apparatus 1 to capture the to-be-tested object, the drop orientation test device may control the cleaning mechanism 7 to clean the sundries on the drop plate 3 from the drop plate 3, to enable that the to-be-tested object only collides with the drop plate 3 during the next drop test of the to-be-tested object, and is not affected by the sundries on the drop plate 3. Therefore, an impact of a material of the drop plate 3 on performance of the to-be-tested object can be accurately analyzed.

A specific implementation form of the cleaning mechanism 7 is not limited in this embodiment of this application. For example, the cleaning mechanism 7 may specifically include: a cleaning roller 71 and a sundry storage apparatus 72 (not shown in FIG. 7), where the cleaning roller 71 may be disposed on at least one of the four sides of the drop plate 3, and the sundry storage apparatus 72 may be disposed on an opposite side of the cleaning roller 71, or may be disposed below the drop plate 3, or may be disposed on edges of the four sides of the drop plate 3, so that the cleaning roller 71 rotates on the drop plate 3 to clean the sundries into the sundry storage apparatus 72, to clear the drop plate 3.

Still with reference to FIG. 7, to comprehensively simulate an impact of different drop plates 3 on dropping of the to-be-tested object, in this embodiment of this application, the drop orientation test device may further include a drop plate replacement apparatus 8. After controlling the first orientation generation apparatus 1 to capture the to-be-tested object, the drop orientation test device may control the drop plate replacement apparatus 8 to change a current drop plate 3 to another drop plate 3, the drop plate replacement apparatus 8 can be disposed to replace a damaged drop plate 3 in time, to ensure that performance of the drop plate 3 is not affected by an irrelevant factor in a drop test process, and to further fully cover a scenario in which a user drops the to-be-tested object.

When the current drop plate 3 is damaged and the material of the drop plate 3 does not need to be changed, the drop orientation test device may change the current drop plate 3 to the another drop plate 3, where the current drop plate 3 and the another drop plate 3 are made of a same material.

When the material of the drop plate 3 needs to be changed and no matter whether the current drop plate 3 is damaged, the drop orientation test device may change the current drop plate 3 to the another drop plate 3, where the current drop plate 3 and the another drop plate 3 are made of different materials.

The material of the drop plate 3 is not limited in this embodiment of this application. Optionally, the material of the drop plate 3 is any one or any combination of glass, wood, asphalt, and marble.

In addition, as shown in FIG. 8, the drop orientation test device may further include: a protection door 9, an operation interface 10, an operation switch 11, a transmission channel 12 of the to-be-tested object, and the like. The protection door 9 may be disposed outside the another apparatus in the drop orientation test device, and has a protection function, to prevent an object generated after the to-be-tested object in the drop orientation test device collides with the drop plate 3 from bursting onto the operator. The operation interface 10 may provide the operator with a specific parameter for performing a specific drop test on the to-be-tested object, such as a rotation angle, a quantity of drop times, a first preset height, a second preset height, and a material of the drop plate 3. In addition, the operation interface 10 may further display an actual position of the to-be-tested object in the drop orientation test device in real time. This facilitates the operator to observe, so that the drop test of the to-be-tested object is performed smoothly. The operation switch 11 may include but is not limited to a power switch, an emergency stop switch, and the like, to help the operator handle various emergency situations. The transmission channel 12 of the to-be-tested object may transport the to-be-tested object to the placement table 4, to implement an automatic drop test of the to-be-tested object by using the drop orientation test device.

The drop orientation control method is provided in this embodiment of this application. The method is applied to the drop orientation test device, and the drop orientation control apparatus divides the rotation angle actually required by the to-be-tested object into the first angle and the second angle based on the first rotation axis and the second rotation axis that are perpendicular to each other. Then, the first orientation generation apparatus 1 is controlled to rotate the captured to-be-tested object by the first angle around the first rotation axis, the first orientation generation apparatus 1 is controlled to transfer the to-be-tested object rotated by the first angle to the second orientation generation apparatus 2, and the second orientation generation apparatus 2 is controlled to rotate the to-be-tested object rotated by the first angle around the second rotation axis by the second angle, so that the to-be-tested object presents any rotation angle that may actually occur. Then, the second orientation rotation apparatus is controlled to release the to-be-tested object at this time, so that the to-be-tested object drops onto the drop plate 3, to complete the drop test process of the to-be-tested object. In this embodiment of this application, the to-be-tested object is separately rotated around the two rotation axes that are perpendicular to each other, so that any actual rotation angle of the to-be-tested object can be generated, and various actual orientations of the to-be-tested object can be comprehensively simulated. This resolves problems with approaches where a usage scenario of a user cannot be fully covered.

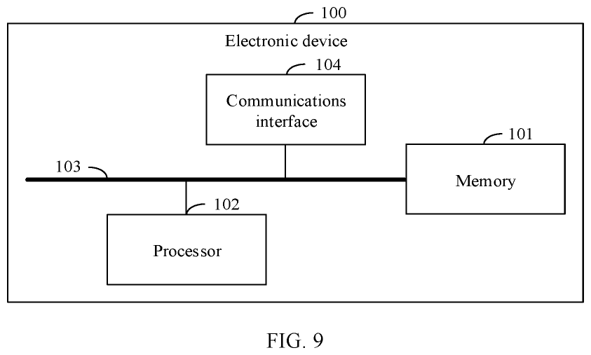

For example, an embodiment of this application further provides an electronic device. FIG. 9 is a schematic diagram of a hardware structure of an electronic device according to an embodiment of this application. As shown in FIG. 9, the electronic device 100 may be integrated into a drop orientation test device, or may be a separately disposed external device being connected to the drop orientation test device. The external device includes but is not limited to any device capable of storing program code, such as a USB flash drive, a removable hard disk, a read-only memory (ROM), a random access memory (RAM), a magnetic disk, or an optical disc, and is configured to implement an operation corresponding to the drop orientation test device in any one of the foregoing method embodiments. The electronic device 100 in this embodiment of this application may include a memory 101 and a processor 102. The memory 101 and the processor 102 may be connected by using a bus 103.

The memory 101 is configured to store program code.

The processor 102 invokes the program code, and when the program code is executed, is configured to perform the drop orientation control method in any one of the foregoing embodiments. For details, refer to related descriptions in the foregoing method embodiments.

Optionally, this embodiment of this application further includes a communications interface 104. The communications interface 104 may be connected to the processor 102 by using the bus 103. The processor 102 may control the communications interface 103 to implement the foregoing receiving and sending functions of the electronic device 100.

The electronic device in this embodiment of this application may be used to execute the technical solutions of the foregoing method embodiments. The implementation principles and technical effects are similar, and are not further described herein.

In the several embodiments provided in this application, it should be understood that the disclosed device and method may be implemented in other manners. For example, the described device embodiment is merely an example. For example, division into the modules is merely logical function division and may be other division in actual implementation. For example, a plurality of modules may be combined or integrated into another system, or some features may be ignored or may not be performed. In addition, the displayed or discussed mutual couplings or direct couplings or communication connections may be implemented through some interfaces. The indirect couplings or communication connections between the apparatuses or modules may be implemented in electronic, mechanical, or other forms.

The modules described as separate parts may or may not be physically separate, and parts displayed as modules may or may not be physical units, may be located in one position, or may be distributed on a plurality of network units. Some or all the modules may be selected based on actual needs to achieve the objectives of the solutions of the embodiments of this application.

In addition, functional modules in the embodiments of this application may be integrated into one processing unit, or each of the modules may exist alone physically, or two or more modules are integrated into one unit. The unit integrated from the modules may be implemented in a form of hardware, or may be implemented in a form of hardware in addition to a software functional unit.

When the foregoing integrated module is implemented in a form of a software functional module, the integrated unit may be stored in a computer-readable storage medium. The software function module is stored in a storage medium and includes several instructions for instructing a computer device (which may be a personal computer, a server, or a network device) or a processor to perform some of the steps of the methods described in the embodiments of this application.

It should be understood that the processor may be a central processing unit (CPU), or may be another general-purpose processor, a digital signal processor (DSP), an application-specific integrated circuit (ASIC), or the like. The general purpose processor may be a microprocessor, or the processor may be any conventional processor or the like. The steps of the methods disclosed with reference to the present invention may be directly performed by a hardware processor, or may be performed by using a combination of hardware of the processor and a software module.

The memory may include a high-speed RAM memory, or may further include a non-volatile memory (NVM), for example, at least one magnetic disk memory. Alternatively, the memory may be a USB flash drive, a removable hard disk, a read-only memory, a magnetic disk, an optical disc, or the like.

The bus may be an industry standard architecture (ISA) bus, a peripheral component interconnect (PCI) bus, an extended industry standard architecture (EISA) bus, or the like. The bus may be classified into an address bus, a data bus, a control bus, and the like. For ease of representation, the bus in the accompanying drawings of this application is not limited to only one bus or only one type of bus.

This application further provides a readable storage medium. The readable storage medium stores an execution instruction. When at least one processor of an electronic device executes the execution instruction, the electronic device performs the drop orientation control method in the foregoing method embodiment.

This application further provides a chip. The chip is connected to a memory, or a memory is integrated in the chip, and when a software program stored in the memory is executed, the drop orientation control method in the foregoing method embodiment is implemented.

This application further provides a program product. The program product includes an execution instruction, and the execution instruction is stored in a readable storage medium. At least one processor of an electronic device may read the executable instruction from the readable storage medium, and the at least one processor executes the executable instruction, so that the electronic device implements the drop orientation control method in the foregoing method embodiment.

A person of ordinary skill in the art may understand that all or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, DVD), a semiconductor medium (for example, a solid-state drive Solid State Disk (SSD)), or the like.

1-39. (canceled)

40. A drop orientation control method performed by a drop orientation test system, comprising:
controlling a first orientation generation device of the drop orientation test system to capture a to-be-tested object and drive the to-be-tested object to rotate by a first angle around a first rotation axis;
controlling the first orientation generation device to transfer the to-be-tested object that has been rotated by the first angle to a second orientation generation device of the drop orientation test system;
controlling the second orientation generation device to capture the to-be-tested object from the first orientation generation device and drive the to-be-tested object to rotate by a second angle around a second rotation axis, wherein the first rotation axis and the second rotation axis are perpendicular to each other; and
controlling the second orientation generation device to release the to-be-tested object to drop the to-be-tested object onto a drop plate;
controlling a camera to take a picture at an initial moment when the to-be-tested object is in contact with the drop plate; and
controlling, based on the picture, the first orientation generation device to capture the to-be-tested object and place the to-be-tested object on a placement table of the drop orientation test system.

41. The method of claim 40, wherein the controlling the first orientation generation device to capture the to-be-tested object comprises:
controlling the first orientation generation device to capture the to-be-tested object from the placement table, wherein the placement table is configured to place the to-be-tested object; and
controlling the placement table to drive the to-be-tested object to rotate until a preset surface of the to-be-tested object faces a capturing direction of the first orientation generation device.

42. The method of claim 40, wherein the first orientation generation device comprises a mechanical arm and a first capturing device, wherein
the first capturing device is configured to capture the to-be-tested object, and the mechanical arm is configured to drive the to-be-tested object to rotate.

43. The method of claim 40, wherein before the controlling the second orientation generation device to release the to-be-tested object, the method further comprises:
controlling the second orientation generation device to move to a first preset height.

44. The method of claim 40, wherein the controlling the second orientation generation device to release the to-be-tested object comprises:
controlling the second orientation generation device that captures the to-be-tested object to freely drop until the second orientation generation device releases the to-be-tested object when the second orientation generation device is at a second preset height.

45. The method of claim 40, wherein the second orientation generating device comprises a drop support and a drop body, wherein
the drop support comprises a guide rail, and the drop body moves upward and downward along the guide rail;
the drop body is configured to capture the to-be-tested object and drive the to-be-tested object to rotate, and wherein the drop body comprises a drop head and a second capturing device;
the second capturing device is configured to capture the to-be-tested object, and the drop head is configured to drive the to-be-tested object to rotate; and
wherein the drop head comprises an upper drop head and a lower drop head, wherein the upper drop head is configured to drive the drop body to move upward and downward, and drive the lower drop head to drive the to-be-tested object to freely drop.

46. The method according to claim 40, wherein four barriers are disposed at four sides of the drop plate, wherein the barriers are configured to prevent the to-be-tested object from dropping out of the drop plate;
determining, based on the picture, whether the to-be-tested object leans against one or more of the barriers; and
when the to-be-tested object is determined to be leaning against one or more of the barriers, controlling the one or more of the barriers to be extracted from the drop position, to enable the to-be-tested object to slide down and lie on the drop plate, so that the first orientation generation device captures the to-be-tested object.

47. The method of claim 40, wherein the drop orientation test device further comprises a cleaning mechanism, and after the controlling the first orientation generation apparatus to capture the to-be-tested object, the method further comprises:
controlling the cleaning mechanism to clear sundries on the drop plate from the drop plate; and
wherein the drop orientation test device further comprises a drop plate replacement apparatus, and after the controlling the first orientation generation apparatus to capture the to-be-tested object, the method further comprises:
controlling the drop plate replacement apparatus to replace a current drop plate with another drop plate, wherein a material of the current drop plate is different from a material of the another drop plate, and wherein a material of the drop plate comprises any one of glass, wood, asphalt, or marble.

48. A drop orientation test system, comprising:
a first orientation generation device configured to:
capture a to-be-tested object and drive the to-be-tested object to rotate by a first angle around a first rotation axis, and
transfer the to-be-tested object that has been rotated by the first angle to a second orientation generation device;
the second orientation generation device configured to:
capture the to-be-tested object from the first orientation generation device and drive the to-be-tested object to rotate by a second angle around a second rotation axis, wherein the first rotation axis and the second rotation axis are perpendicular to each other, and
release the to-be-tested object to drop the to-be-tested object onto a drop plate;
a camera configured to take a picture at an initial moment when the to-be-tested object is in contact with the drop plate; and
the first orientation generation device further configured to capture the to-be-tested object and place the to-be-tested object on a placement table of the drop orientation test system.

49. The test system of claim 48, wherein
the placement table is configured to place the to-be-tested object; and
the first orientation generation device is configured to capture the to-be-tested object from the placement table;
wherein the placement table is further configured to drive the to-be-tested object to rotate until a preset surface of the to-be-tested object faces a capturing direction of the first orientation generation device.

50. The test system of claim 48, wherein the first orientation generation device comprises a mechanical arm and a first capturing device, wherein
the first capturing device is configured to capture the to-be-tested object, and the mechanical arm is configured to drive the to-be-tested object to rotate.

51. The test system of claim 48, wherein the second orientation generation device is further configured to move to a first preset height before releasing the to-be-tested object.

52. The test system of claim 48, wherein the second orientation generation device is configured to capture the to-be-tested object to freely drop until the second orientation generation device releases the to-be-tested object when the second orientation generation device is at a second preset height.

53. The test system of claim 48, wherein the second orientation generating device comprises a drop support and a drop body, wherein
the drop support comprises a guide rail, and the drop body moves upward and downward along the guide rail; and
the drop body is configured to capture the to-be-tested object and drive the to-be-tested object to rotate, and the drop body comprises a drop head and a second capturing device;
the second capturing device is configured to capture the to-be-tested object, and the drop head is configured to drive the to-be-tested object to rotate; and
wherein the drop head comprises an upper drop head and a lower drop head, wherein
the upper drop head is configured to drive the drop body to move upward and downward, and drive the lower drop head to drive the to-be-tested object to freely drop.

54. The test system of claim 48, wherein four barriers are disposed at four sides of the drop plate, wherein the barriers are configured to prevent the to-be-tested object from dropping out of the drop plate; and
wherein the barriers are further configured to be extracted from the drop position when the to-be-tested object leans against one or more of the barriers, to enable the to-be-tested object to slide down and lie on the drop plate, so that the first orientation generation device captures the to-be-tested object.

55. The test system of claim 48, wherein the drop orientation test device further comprises:
a cleaning mechanism configured to: after the first orientation generation device captures the to-be-tested object, clear sundries on the drop plate from the drop plate.

56. The test system of claim 48, wherein the drop orientation test device further comprises:
a drop plate replacement device configured to replace a current drop plate with another drop plate after the first orientation generation device captures the to-be-tested object.

57. The test system of claim 56, wherein a material of the current drop plate is different from a material of the another drop plate.

58. The test system of claim 56, wherein a material of the drop plate is any one of glass, wood, asphalt, and marble.

59. A non-transitory computer readable storage medium, wherein the non-transitory computer readable storage medium stores a computer program, which when executed by a processor, causes an electronic device to:
control a first orientation generation device to capture a to-be-tested object and drive the to-be-tested object to rotate by a first angle around a first rotation axis;
control the first orientation generation device to transfer the to-be-tested object that has been rotated by the first angle to a second orientation generation device;
control the second orientation generation device to capture the to-be-tested object from the first orientation generation device and drive the to-be-tested object to rotate by a second angle around a second rotation axis, wherein the first rotation axis and the second rotation axis are perpendicular to each other;
control the second orientation generation device to release the to-be-tested object, to enable the to-be-tested object to drop onto a drop plate;
control a camera to take a picture at an initial moment when the to-be-tested object is in contact with the drop plate; and
control, based on the picture, the first orientation generation device to capture the to-be-tested object and place the to-be-tested object on a placement table.
